(19) United States
(12) Patent Application Publication
(10) Pub. No.: US 2016/0381274 A1
(43) Pub. Date: Dec. 29, 2016

(54) Image Sensing Module

(71) Applicant: NOVATEK Microelectronics Corp., Hsin-Chu (TW)

(72) Inventors: Wei-Lung Liu, Hsinchu County (TW); Min-Hui Chu, Hsinchu County (TW); Hua-Yen Hsiang, Hsinchu City (TW); Shen-Fu Tsai, Taoyuan City (TW)

(21) Appl. No.: 14/749,661

(22) Filed: Jun. 25, 2015

(51) Int. Cl. H04N 5/235

(52) U.S. Cl. CPC H04N 5/2353

(57) ABSTRACT

An image sensing module includes a plurality of pixels forming a pixel array, wherein each of the pixels consists of a plurality of sub-pixels with the same color; and a control circuit coupled to the sub-pixels for controlling exposure periods of the sub-pixels.

### BACKGROUND OF THE INVENTION

1. Field of the Invention

The present invention relates to an image sensing module, and more particularly, to an image sensing module capable of generating image data corresponding to different exposure periods in a single capturing process.

2. Description of the Prior Art

Image capturing device are widely utilized in digital electronic products, such as scanners, digital cameras, mobile phones and personal digital assistants. The most common types of image capturing device are Complementary Metal Oxide Semiconductors (CMOS) and Charge Coupled Device (CCD). These image capturing device are both silicon semiconductor devices utilized for sensing light and transferring the sensed light into electricity. The electricity generated by the image capturing device is transferred into measureable voltages, from which digital data can be acquired.

Please refer to FIG. 1, which is a characteristic diagram of the luminous flux received by a conventional image capturing device and the voltage generated by the conventional image capturing device. The voltage corresponds to the image information sensed by the image capturing device. As shown in FIG. 1, the image capturing device transfers the luminous flux to a measureable voltage once the luminous flux received by the image capturing device exceeds a minimum luminous flux LFmin. In other words, the image capturing device acquires valid image information when the luminous flux received by the image capturing device during an image sensing time period exceeds the minimum luminous flux LFmin. Thus, if the minimum luminous flux is made smaller, the image capturing device may acquire image information corresponding to less luminance.

The image sensing generates a maximum voltage Vmax when the luminous flux received by the image capturing device exceeds a maximum luminous flux LFmax. In other words, the image capturing device outputs the maximum voltage Vmax when different image information having corresponding luminous flux exceeding the maximum luminous flux LFmax are received by the image capturing device. In such a condition, the different image information cannot be identified. Therefore, when the maximum luminous flux LFmax becomes higher, the luminous flux range of the image information which can be identified by the image capturing device becomes broader. The prior art provides a dynamic range (DR) as an indicator for evaluating the luminous flux range of the image information which is capable of being identified by the image capturing device, i.e. the range of the luminous flux which is received by the image capturing device and is capable of being identified by the image capturing device. The dynamic range is defined as:

$$DR = 20 Log ( \frac{LF max}{LF min} )$$

Generally, when the dynamic range of the image capturing device increases, the luminance differences in the image information which can be sensed by the image capturing device become greater. Thus, how to increase the dynamic range of the image capturing device becomes a topic to be discussed.

### SUMMARY OF THE INVENTION

In order to solve the above problem, the present invention provides an image sensing module capable of generating image data corresponding to different exposure periods in single capturing process.

In an aspect, the present invention discloses an image sensing module. The image sensing module comprises a plurality of pixels forming a pixel array, wherein each of the pixels consists of a plurality of sub-pixels with the same color; and a control circuit coupled to the sub-pixels for controlling exposure periods of the sub-pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a characteristic diagram of the luminous flux received by a conventional image capturing device and the voltage generated by the conventional image capturing device.

FIG. 2 is a schematic diagram of an image capturing device according to an example of the present invention.

FIG. 3A is a schematic diagram of a pixel of the image sensing module shown in FIG. 2.

FIG. 3B is a schematic diagram of a simplified circuit of the pixel shown in FIG. 3A.

FIG. 4 is a schematic diagram of related signals when the pixel and the output circuit shown in FIG. 3B operates.

FIG. 5A is a schematic diagram of a pixel of the image sensing module shown in FIG. 2.

FIG. 5B is a schematic diagram of a simplified circuit of the pixel shown in FIG. 5A.

FIG. 6 is a schematic diagram of related signals when the pixel and the output circuit shown in FIG. 5B operates.

FIG. 7 is a schematic diagram of a pixel of the image sensing module shown in FIG. 2.

FIG. 8 is a schematic diagram of a pixel of the image sensing module shown in FIG. 2.

FIG. 9 is a schematic diagram of a pixel of the image sensing module shown in FIG. 2.

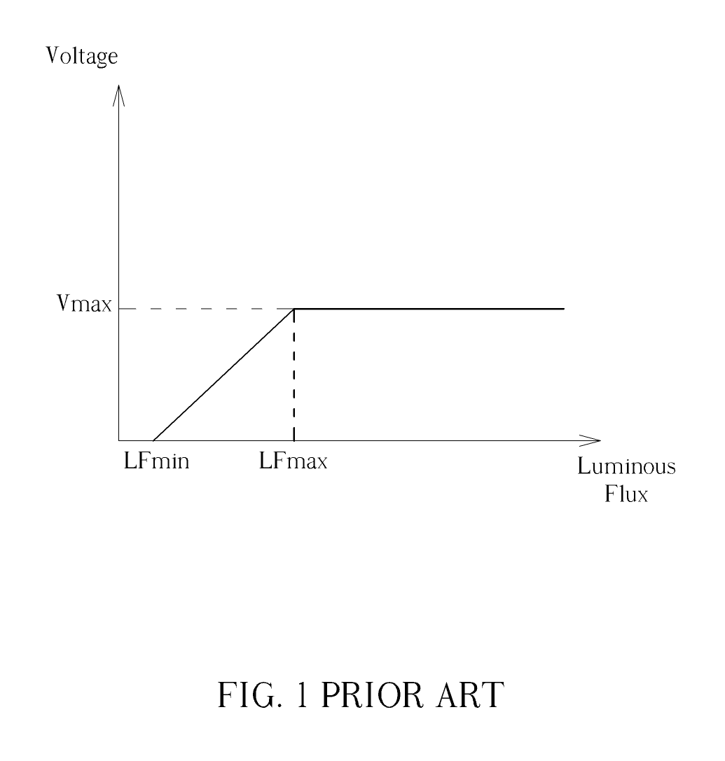

### DETAILED DESCRIPTION

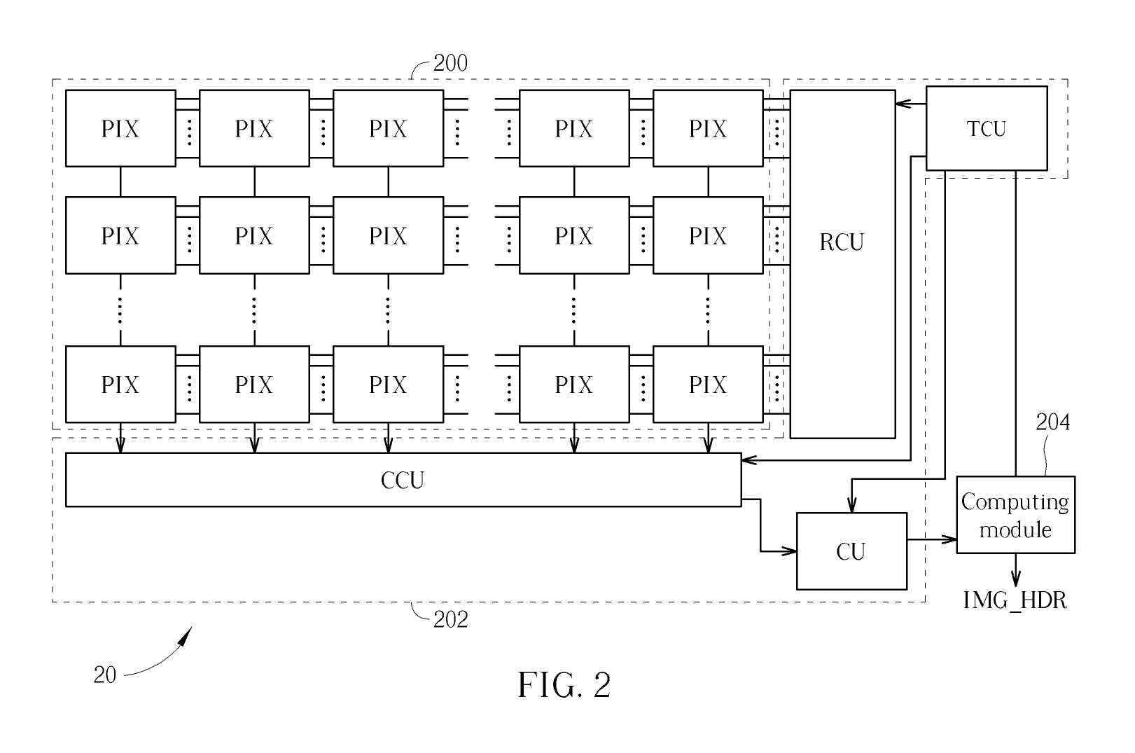

Please refer to FIG. 2, which is a schematic diagram of an image capturing device 20 according to an example of the present invention. The image capturing device 20 may be an electronic product equipping with the image capturing function, such as a smart phone, a digital camera, a tablet, a surveillance camera and are not limited herein. As shown in FIG. 2, the image capturing device 20 comprises an image sensing module 200, a control module 202 and a computing module 204. The image sensing module 200 may be a photo diode array and comprises a plurality of pixels PIX and a control unit CON (not shown in FIG. 2) configured in the plurality of pixels PIX. The control module 202 comprises a timing control unit TCU, a raw control unit RCU, a column control unit CCU and a converting unit CU and is utilized for controlling the image sensing module 200 to sense the scene captured by the image capturing device 20 and for outputting the pixel data generated by the image sensing module 200 to the computing module 204. The computing module 204 is utilized for generating sub-images corresponding to the captured scene according to the pixel data outputted by the control module 202. Note that, each of the pixels PIX is divided into a plurality of sub-pixels and the plurality of sub-pixel is adjacent to each other. Via adjusting the exposure periods of the plurality of sub-pixels, the image capturing device 20 can acquire multiple sub-images corresponding to different exposure periods in a single capturing process. The computing module 204 therefore can generate a high dynamic range image IMG_HDR according to the sub-images corresponding to different exposure periods.

In details, the timing control unit TCU is utilized for generating clock signals for the row control unit RCU, the column control unit CCU and the converting unit CU. According to the control signals generated by the row control unit RCU and the column control unit CCU, the control unit CON controls the pixels PIX in the image sensing module 200 to sense the light of the captured scene during different exposure periods and to generate corresponded pixel data to the column control unit CCU. After receiving the pixel data generated by the image sensing module 200, the column control unit CCU transmits the pixel data to the converting unit CU and the converting unit CU accordingly converts the pixel data to the format (e.g. digital format) required by the computing module 204. The computing module 204 generates the sub-images corresponding to different exposure periods and combines the sub-images to generate the HDR image IMG_HDR.

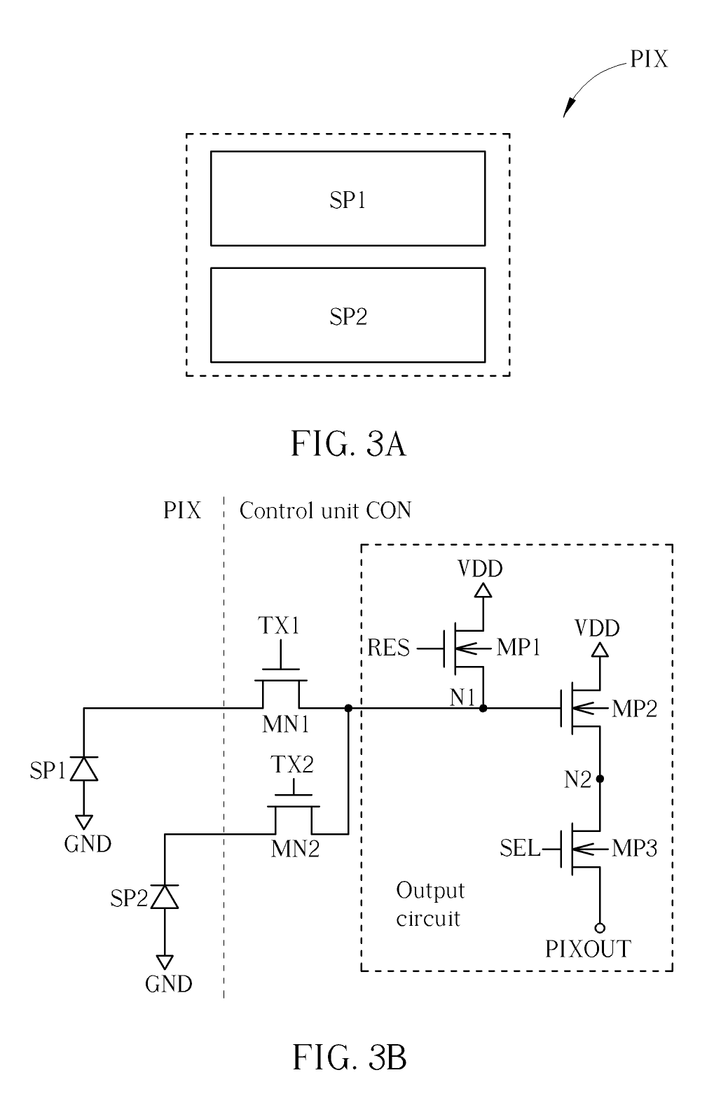

Please refer to FIG. 3A, which is a schematic diagram of a pixel PIX of the image sensing module 200 shown in FIG. 2. In this example, the pixel PIX is divided into sub-pixels SP1 and SP2, wherein the sub-pixels SP1 and SP2 are corresponding to the same color and the sub-pixel SP2 is located at the bottom side of the sub-pixel SP1. Please refer to FIG. 3B, which is a schematic diagram of a simplified circuit of the pixel PIX shown in FIG. 3A and a part of control unit CON. As shown in FIG. 3B, the pixel PIX comprises the sub-pixels SP1 and SP2, and the control unit CON comprises the transistors MN1 and MN2 and an output circuit comprising transistors MP1-MP3. The transistor MN1 comprises a source coupled to the sub-pixel SP1, a drain coupled to a node N1 and a gate coupled to a control signal TX1 generated by the control module 202. That is, the transistor MN1 can be considered as a switch, which is coupled between the sub-pixel SP1 and the node N1 and is controlled by the control signal TX1. Similarly, the transistor MN2 comprises a source coupled to the sub-pixel SP2, a drain coupled to the node N1 and a gate coupled to a control signal TX2 generated by the control module 202. The output circuit is utilized for outputting pixel data PD1 and PD2 of the sub-pixels SP1 and SP2. The transistor MP1 comprises a source coupled to the node N1, a drain coupled to a voltage source VDD and a gate coupled to a control signal RES. The transistor MP1 comprises a source coupled to the node N1, a drain coupled to a voltage source VDD and a gate coupled to a control signal RES. The transistor MP2 comprises a source coupled to a node N2, a drain coupled to the voltage source VDD and a gate coupled to the node N1. The transistor MP3 comprises a source coupled to an output node PIXOUT, a drain coupled to the node N2 and a gate coupled to a control signal SEL, wherein the output node PIXOUT is coupled to the control module 202 for outputting the pixel data PD1 and PD2 generated by the sub-pixels SP1 and SP2.

Via appropriately adjusting the control signals TX1, TX2, RES, and SEL, the control unit CON controls the sub-pixels SP1 and SP2 to sense the light corresponding to the captured scene during different exposure periods TE1 and TE2 and to output the pixel data PD1 and PD2 to the control module 202. According to the pixel data PD1 and PD2 of each pixel PIX in the image sensing module 200, the computing module 204 generates the sub-images of different exposure periods and combine the sub-images of different exposure periods to generate the HDR image IMG_HDR.

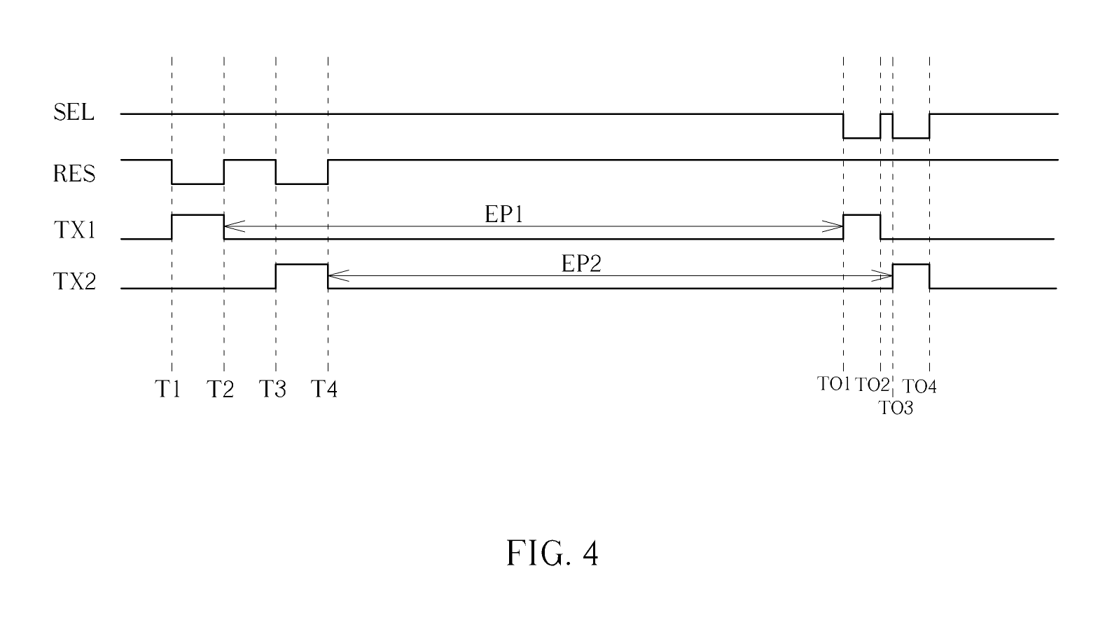

As to the detailed operations of the pixel PIX and the output circuit shown in FIG. 3B, please refer to FIG. 4, which illustrates the related signals when the pixel PIX and the control unit CON shown in FIG. 3B operates. At a time T1, the control signal TX1 is at a high-logic voltage level (e.g. the voltage of the voltage source VDD) to conduct the connection between the sub-pixel SP1 and the node N1 and the control signal RES is at a low-logic voltage level (e.g. the voltage of the ground GND) to conduct the connection between the voltage source VDD and the node N1. In such a condition, the voltage of the sub-pixel SP1 is reset to the voltage of the voltage source VDD. At a time T2, the control signal TX1 is switched to the low-logic voltage level to disconnect the connection between the sub-pixel SP1 and the node N1 and the sub-pixel SP1 starts to sense the light corresponding to the captured scene. Similarly, the control signal TX2 is at the high-logic voltage level to conduct the connection between the sub-pixel SP2 and the node N1 and the control signal RES is at the low-logic voltage level to conduct the connection between the voltage source VDD and the node N1 at a time T3. The voltage of the sub-pixel SP2 is reset to the voltage of the voltage source VDD. At a time T4, the control signal TX2 is switched to the low-logic voltage level to disconnect the connection between the sub-pixel SP2 and the node N1 and the control signal RES is switched to the high-logic voltage level to disconnect the connection between the voltage source VDD and the node N1. The sub-pixel SP2 begins to sense the light corresponding to the captured scene.

Between times TO1 and TO2, the control signal TX1 is switched to the high-logic voltage level to conduct the connection between the sub-pixel SP1 and the node N1 and the control signal SEL is switched to the low-logic voltage level to conduct the connection between the node N2 and the output node PIXOUT. Under such a condition, the voltage generated by the sub-pixel SP1 sensing the captured scene is outputted to the output node PIXOUT as the pixel data PD1. That is, the sub-pixel SP1 senses the captured scene during an exposure period EP1 from the time T2 to the time TO1 and outputs the sensed voltage as the pixel data PD1. Similarly, the control signal TX2 is switched to the high-logic voltage level to conduct the connection between the sub-pixel SP2 and the node N1 and the control signal SEL is switched to the low-logic voltage level to conduct the connection between the node N2 and the output node PIXOUT between times TO3 and T04. The voltage generated by the sub-pixel SP2 sensing the captured scene is outputted to the output node PIXOUT as the pixel data PD2. That is, the sub-pixel SP2 senses the captured scene during an exposure period EP2 from the time T4 to the time TO3 and outputs the sensed voltage as the pixel data PD2. The computing module 204 generates the sub-image image IMG_1 sensed during the exposure period EP1 according to the pixel data PD1 of each pixel PIX in the image sensing module 200 and generates the sub-image IMG_2 sensed during the exposure period EP2 according to the pixel data PD2 of each pixel PIX in the image sensing module 200. As a result, the image capturing device 20 can acquire the sub-images IMG_1 and IMG_2 corresponding to different exposure periods in single capturing process and accordingly generate the HDR image IMG_HDR.

Note that, since the exposure period EP1 overlaps the exposure period EP2, the image details in the sub-images IMG_1 and IMG_2 should be approximately the same. The image quality of the HDR image IMG_HDR generated according to the sub-images IMG_1 and IMG_2 is therefore improved.

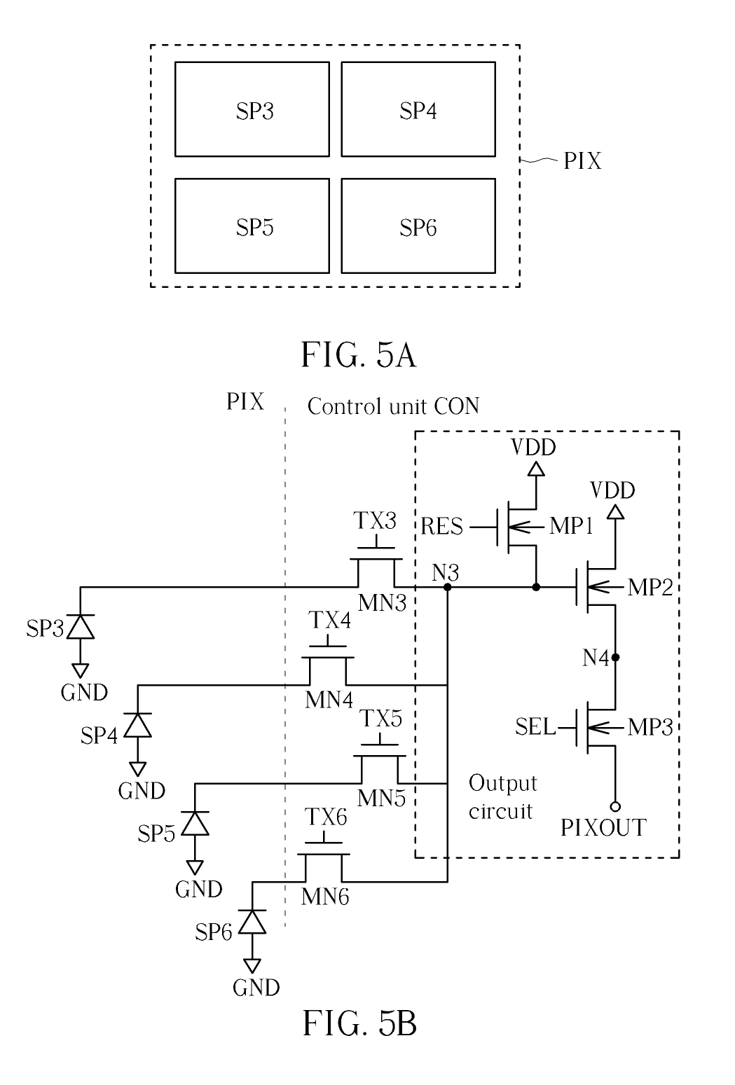

Please refer to FIG. 5A, which is a schematic diagram of a pixel PIX shown in FIG. 2. In this example, the pixel PIX is divided into 4 sub-pixels SP3-SP6 corresponding to the same color. The sub-pixel SP4 is located at the right side of the sub-pixel SP3, the sub-pixel SP5 is located at the bottom side of the sub-pixel SP3 and the sub-pixel SP6 is located at the bottom side of the sub-pixel SP4 and the right side of the sub-pixel SP5. Please refer to FIG. 5B, which is a schematic diagram of a simplified circuit of the pixel PIX shown in FIG. 5A and a part of control circuit CON. As shown in FIG. 5B, the pixel PIX comprises the sub-pixels SP3-SP6, and the control unit CON comprises the transistors MN3-MN6 and the output circuit comprising transistors MP1-MP3. The transistor MN3 comprises a source coupled to the sub-pixel SP3, a drain coupled to a node N3 and a gate coupled to a control signal TX3 generated by the control module 202. That is, the transistor MN3 can be regarded as a switch, which is coupled between the sub-pixel SP3 and the node N3 and is controlled by the control signal TX3. Similarly, the transistor MN4 comprises a source coupled to the sub-pixel SP4, a drain coupled to the node N3 and a gate coupled to a control signal TX4 generated by the control module 202. The transistor MN5 comprises a source coupled to the sub-pixel SP5, a drain coupled to the node N3 and a gate coupled to a control signal TX5 generated by the control module 202. The transistor MN6 comprises a source coupled to the sub-pixel SP6, a drain coupled to the node N3 and a gate coupled to a control signal TX6 generated by the control module 202. The output circuit shown in FIG. 5B is similar to that shown in FIG. 3B, and thus the components and signals with the same function are denoted by the same symbols. The operation principles of the output circuit shown in FIG. 5B can be referred to the above and are not described herein for brevity.

Via appropriately adjusting the control signals TX3-TX6, RES, and SEL, the control unit CON controls the sub-pixels SP3-SP6 to sense the light corresponding to the captured scene during 4 different exposure periods TE3-TE6 and to output the pixel data PD3-PD6 to the control module 202. According to the pixel data PD3-PD6 of each pixel PIX in the image sensing module 200, the computing module 204 therefore can generate the sub-images of 4 different exposure periods in a single time of capturing process.

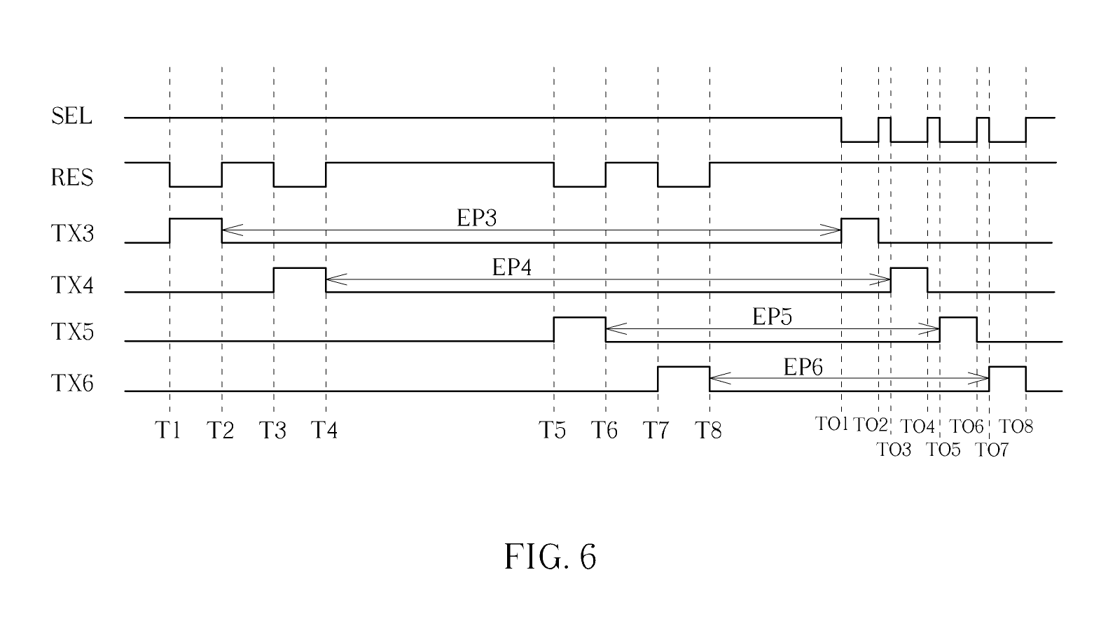

As to the detailed operations of the pixel PIX and the control circuit CON shown in FIG. 5B, please refer to FIG. 6 which illustrates the related signals when the pixel PIX and the output circuit shown in FIG. 5B operates. At the time T1, the control signal TX3 is at a high-logic voltage level (e.g. the voltage of the voltage source VDD) to conduct the connection between the sub-pixel SP3 and the node N3 and the control signal RES is at a low-logic voltage level (e.g. the voltage of the ground GND) to conduct the connection between the voltage source VDD and the node N3. In such a condition, the voltage of the sub-pixel SP3 is reset to the voltage of the voltage source VDD. At the time T2, the control signal TX3 is switched to the low-logic voltage level to disconnect the connection between the sub-pixel SP3 and the node N3 and the control signal RES is switched to the high voltage level to disconnect the connection between the voltage source VDD and the node N3. The sub-pixel SP3 starts to sense the light corresponding to the captured scene. Similarly, the voltage of the sub-pixel SP4 is reset to the voltage of the voltage source VDD at the time T3 and begins to sense the light corresponding to the captured scene at the time T4. The voltage of the sub-pixel SP5 is reset to the voltage of the voltage source VDD at a time T5 and begins to sense the light corresponding to the captured scene at the time T6. The voltage of the sub-pixel SP6 is reset to the voltage of the voltage source VDD at a time T7 and begins to sense the light corresponding to the captured scene at the time T8.

Next, the control signal TX3 is switched to the high-logic voltage level to conduct the connection between the sub-pixel SP3 and the node N3 and the control signal SEL is switched to the low-logic voltage level to conduct the connection between the node N4 and the output node PIXOUT between the times TO1 and TO2. Under such a condition, the voltage generated by the sub-pixel SP3 sensing the captured scene is outputted to the output node PIXOUT as the pixel data PD3. That is, the sub-pixel SP3 senses the captured scene during an exposure period EP3 from the time T2 to the time TO1 and outputs the sensed voltage as the pixel data PD3. Similarly, the sub-pixel SP4 senses the captured scene during an exposure period EP4 from the time T4 to the time TO3 and outputs the sensed voltage as the pixel data PD4. The sub-pixel SP5 senses the captured scene during an exposure period EP5 from the time T6 to the time TO5 and outputs the sensed voltage as the pixel data PD5. The sub-pixel SP6 senses the captured scene during an exposure period EP6 from the time T8 to the time T07 and outputs the sensed voltage as the pixel data PD6.

According to the pixel data PD3, PD4, PD5 and PD6 generated by each of the pixels PIX, the computing module 204 therefore can generate the sub-images IMG_3, IMG_4, IMG_5 and IMG_6, respectively, and combine the sub-images IMG_3-IMG_6 to generate the HDR image IMG_HDR.

Via dividing each pixel of the image sensing module 200 into a plurality of sub-pixels and adjusting the exposure period of each of the plurality of sub-pixels, the image capturing device 20 of the above example generates the sub-images acquired during different exposure periods in a single capturing process and combines the sub-images to generate the HDR image IMG_HDR. According to different applications and design concepts, those skilled in the art may observe appropriate alternations and modifications. For example, some of the plurality of sub-pixels may be corresponding to the same exposure period. In an example, the sub-pixels SP3 and SP6 shown in FIG. 5A sense the captured scene during an exposure period and the sub-pixels SP4 and SP5 shown in FIG. 5A sense the captured scene during another exposure period. In this example, the image capturing device 20 acquires the sub-images corresponding to 2 different exposure periods in single capturing process. In another example, the sub-pixels SP3 and SP6 shown in FIG. 5A sense the captured scene during an exposure period, the sub-pixel SP4 shown in FIG. 5A senses the captured scene during another exposure period and the sub-pixel SP5 shown in FIG. 5A senses the captured scene during still another exposure period. In this example, the image capturing device 20 acquires the sub-images corresponding to 4 different exposure periods in single capturing process.

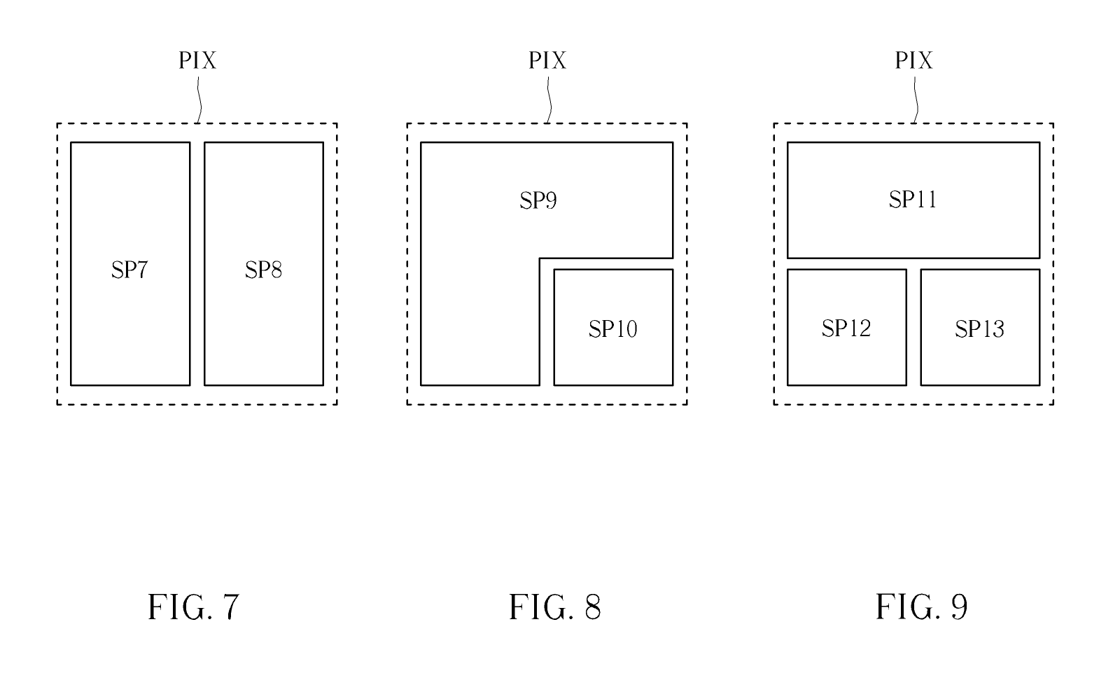

Please refer to FIG. 7, which is a schematic diagram of the pixel PIX shown in FIG. 2. In this example, the pixel PIX is divided into sub-pixels SP7 and SP8, wherein the sub-pixel SP8 is located at the right side of the sub-pixel SP7. The operation principles of the pixel PIX show in FIG. 7 can be referred to those of the pixel PIX shown in FIG. 3A, and are not narrated herein for brevity.

In an example, each of the pixels PIX of the image sensing module 200 is divided into the plurality of sub-pixels with different areas. Please refer to FIGS. 8 and 9, which are schematic diagrams of the pixel PIX shown in FIG. 2. As shown in FIG. 8, the pixel PIX is divided into sub-pixels SP9 and SP10, wherein the area of the sub-pixel SP9 is approximately 3 times greater than that of the sub-pixel SP10. In FIG. 9, the pixel PIX is divided into sub-pixels SP11-SP13. The sub-pixels SP12 and SP13 are located at the bottom side of the sub-pixel SP11, the sub-pixel SP13 is located at the right side of the sub-pixel SP12 and the area of the sub-pixel SP11 is approximately twice greater than those of the sub-pixels SP12 and SP13.

To sum up, the above examples acquires the sub-images with different exposure periods in a single capturing process via dividing each pixel of the image sensing module into a plurality of sub-pixels and adjusting the exposure period of each of the plurality of sub-pixels. The HDR image therefore can be generated in single capturing process.

Those skilled in the art will readily observe that numerous modifications and alterations of the device and method may be made while retaining the teachings of the invention. Accordingly, the above disclosure should be construed as limited only by the metes and bounds of the appended claims.

1. An image sensing module, comprising:
a plurality of pixels forming a pixel array, wherein each of the pixels consists of only a first sub-pixel and a second sub-pixel with the same color; and
a control circuit coupled to the sub-pixels for controlling exposure periods of the sub-pixels;
wherein an area of the first sub-pixel approximates three times greater than an area of the second sub-pixel;
wherein the first sub-pixel and the second sub-pixel have different shapes and form a rectangle.

2. The image sensing module of claim 1, wherein the exposure periods of the first sub-pixel and the second sub-pixel within one pixel are different.

3-11. (canceled)
